(19) United States
(12) Patent Application Publication
(10) Pub. No.: US 2026/0119196 A1
(43) Pub. Date: Apr. 30, 2026

(54) PROPOSAL DEVICE, PROPOSAL SYSTEM, PROPOSAL METHOD, AND RECORDING MEDIUM

(71) Applicant: Mitsubishi Electric Corporation, Chiyoda-ku, Tokyo (JP)

(72) Inventors: Keita TONOIKE, Chiyoda-ku, Tokyo (JP); Yohei ISODA, Chiyoda-ku, Tokyo (JP); Tomoya FUJITA, Chiyoda-ku, Tokyo (JP); Seiji UOZUMI, Chiyoda-ku, Tokyo (JP)

(73) Assignee: Mitsubishi Electric Corporation, Chiyoda-ku, Tokyo (JP)

(21) Appl. No.: 18/835,585

(22) PCT Filed: Feb. 8, 2023
(86) PCT No.: PCT/JP2023/004219

§ 371 Date: Aug. 2, 2024

(30) Foreign Application Priority Data
Feb. 14, 2022 (JP) 2022-020618

(51) Int. Cl. G06F 9/445

(52) U.S. Cl. CPC G06F 9/44505

(57) ABSTRACT

A property specifier specifies an accuracy-related property that is a property affecting the processing accuracy of a working machine, based on current equipment configuration information, operation history information, and accuracy achievement information. A user request acquirer acquires a user request for processing accuracy. A product information acquirer acquires product information indicating at least one of a lineup of components applicable to the working machine or a lineup of control programs applicable to the working machine. An equipment configuration determiner determines a proposed equipment configuration that is an equipment configuration that satisfies the user request and that is the current equipment configuration with at least one of the current component configuration or the current control program being changed, based on the current equipment configuration information, the accuracy-related property, and product information. An information outputter outputs proposed equipment related information that is information related to the proposed equipment configuration.

### TECHNICAL FIELD

The present disclosure relates to a proposal device, a proposal system, a proposal method, and a program.

### BACKGROUND ART

Working machines for processing objects have been known. The working machines suffer from vibration generated during processing, which needs to be reduced to improve the processing accuracy of the working machines. Patent Literature 1 discloses a technique of reducing vibration generated during processing. Patent Literature 1 discloses a numerical control device for a working machine including a motor that displaces and rotates a work material and a tool relative to each other. The numerical control device outputs an instruction indicating driving conditions of the motor to the working machine.

This numerical control device specifies model parameters of a transfer model, so as to minimize the error between a result output from the motor in response to input of an instruction indicating certain driving conditions into the motor and a result output from a transfer model for the working machine in response to application of the same driving conditions to the transfer model. The numerical control device uses this transfer model to determine an instruction for reducing vibration during processing. The model parameters include a moment of inertia, viscous friction, Coulomb friction, and offset load regarding the working machine.

### CITATION LIST

### Patent Literature

Patent Literature 1: Unexamined Japanese Patent Application Publication No. 2020-181424

### SUMMARY OF INVENTION

### Technical Problem

The technique disclosed in Patent Literature 1 is, however, aimed at adjusting the driving conditions of the motor within a range achievable by the current component configuration and control program of the working machine, that is, a range achievable by the current equipment configuration of the working machine. The technique disclosed in Patent Literature 1 thus has limitations in terms of range of adjustment, and may find it difficult to comply with user requests including a request for processing accuracy. Desired is another technique for proposing an equipment configuration of the working machine that complies with the user requests including a request for processing accuracy.

An objective of the present disclosure, which has been accomplished in view of the above problems, is to provide a proposal device, a proposal system, a proposal method, and a program capable of proposing an equipment configuration of a working machine that complies with the user requests including a request for processing accuracy.

### Solution to Problem

In order to achieve the above objective, a proposal device according to the present disclosure includes: equipment configuration acquiring means for acquiring current equipment configuration information indicating a current equipment configuration containing a current component configuration of a working machine and a current control program of the working machine; operation history acquiring means for acquiring operation history information indicating an operation history of the working machine; accuracy achievement acquiring means for acquiring accuracy achievement information indicating a processing accuracy achieved by the working machine; property specifying means for specifying, based on the current equipment configuration information, the operation history information, and the accuracy achievement information, an accuracy-related property that is a property affecting the processing accuracy of the working machine; user request acquiring means for acquiring a user request for processing accuracy; product information acquiring means for acquiring product information indicating at least one of a lineup of components applicable to the working machine or a lineup of control programs applicable to the working machine; equipment configuration determining means for determining, based on the current equipment configuration information, the accuracy-related property, and the product information, a proposed equipment configuration that satisfies the user request and that is the current equipment configuration with at least one of the current component configuration or the current control program being changed; and information outputting means for outputting proposed equipment related information that is information related to the proposed equipment configuration.

### Advantageous Effects of Invention

The proposal device according to the present disclosure determines a proposed equipment configuration that satisfies user requests containing a request for processing accuracy and that is the current equipment configuration with at least one of the current component configuration or the current control program being changed. The present disclosure can therefore achieve proposal of an equipment configuration of the working machine that complies with the user requests including a request for processing accuracy.

### BRIEF DESCRIPTION OF DRAWINGS

FIG. 1 illustrates a configuration of a proposal system according to Embodiment 1;

FIG. 2 illustrates a configuration of a proposal device according to Embodiment 1;

FIG. 3 illustrates a configuration of a working machine according to Embodiment 1;

FIG. 4 illustrates functional components of the proposal system according to Embodiment 1;

FIG. 5 is an explanatory diagram illustrating a method of specifying accuracy-related properties;

FIG. 6 illustrates portions regarded as elastic members in a mechanism analysis model;

FIG. 7 illustrates a mechanism analysis model corresponding to a main unit of the working machine;

FIG. 8 is a flowchart illustrating a proposal process executed by the proposal device according to Embodiment 1;

FIG. 9 is a flowchart illustrating an equipment configuration determining process in FIG. 8;

FIG. 10 is a flowchart illustrating a property specifying process executed by a proposal device according to Embodiment 5;

FIG. 11 is an explanatory diagram illustrating a method of acquiring accuracy database information;

FIG. 12 is a flowchart illustrating a property specifying process executed by a proposal device according to Embodiment 6;

FIG. 13 is an explanatory diagram illustrating a method of acquiring a trained model;

FIG. 14 is a flowchart illustrating a property specifying process executed by a proposal device according to Embodiment 7;

FIG. 15 is a flowchart illustrating a property specifying process executed by a proposal device according to Embodiment 8; and

FIG. 16 is an explanatory diagram illustrating a trained model according to Embodiment 8.

### DESCRIPTION OF EMBODIMENTS

Embodiments of the present disclosure are described in detail below with reference to the accompanying drawings. In the drawings, the components identical or corresponding to each other are provided with the same reference symbol.

### Embodiment 1

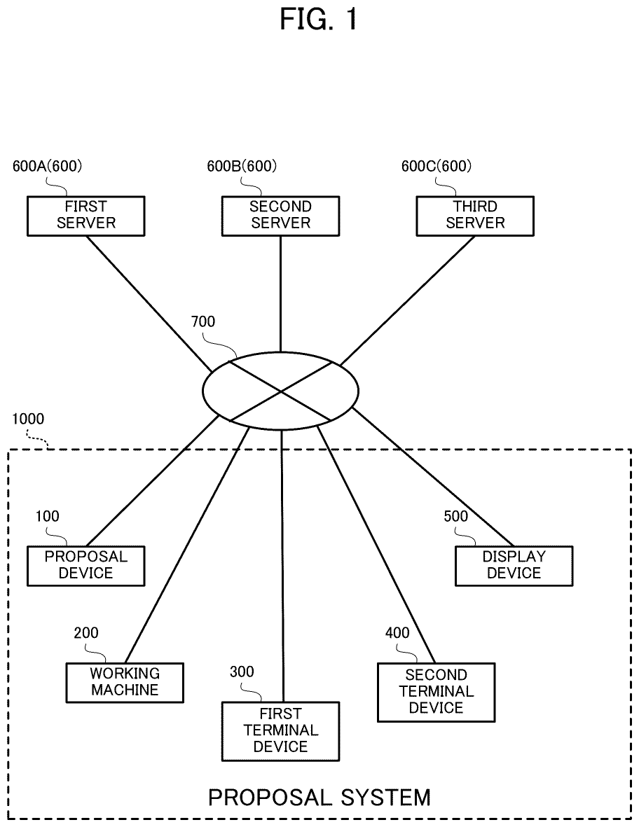

FIG. 1 illustrates a configuration of a proposal system 1000 according to Embodiment 1. The proposal system 1000 proposes an equipment configuration appropriate for a working machine 200. The equipment configuration is a concept that involves a component configuration of components constituting the working machine 200, and a control program installed in the working machine 200. The proposal system 1000 proposes, to a user of the working machine 200, an equipment configuration that satisfies requests from the user. The processing performances required by the user are hereinafter referred to as “required processing performances”, the processing accuracy required by the user is referred to as “required processing accuracy”, and the processing speed required by the user is referred to as “required processing speed”, as appropriate.

The user requests are related to the processing performances of the working machine 200. The user requests in this embodiment contain a request for processing accuracy and a request for processing speed. The processing accuracy is a concept indicating a quality level of a finished object processed by the working machine 200. The processing accuracy corresponds to an error between the size of the ideal processed object and the size of the resulting processed object, for example. The processing speed indicates a speed of fabricating a processed object by the working machine 200. The processing speed corresponds to a length of the object processed by the working machine 200 per unit time, for example.

The proposal system 1000 presents information indicating an equipment configuration that satisfies the user requests, a typical example of which is information indicating a component configuration that satisfies the user requests and a control program that satisfies the user requests. The proposal system 1000 can present various types of information related to an equipment configuration that satisfies the user requests. For example, the proposal system 1000 may propose information indicating components and a control program recommended to satisfy the user requests. The proposal system 1000 may also present information indicating costs for introduction of the recommended components and control program.

Alternatively, the proposal system 1000 may present information indicating a period for introduction of the recommended components and control program. For example, the proposal system 1000 may present information indicating a plan for introduction of working machine options and a plan for installation of an additional control program. The working machine options are pieces of equipment having functions of changing the vibration characteristics of the working machine 200, or the durability of the working machine 200, for example. Examples of the working machine options include driving members, such as servomotors and rack-and-pinion mechanisms, and structural components, such as bed columns and cross rails. The additional control program is a program for controlling a motor by means of a frequency filter to reduce vibration having a specific frequency, a control program for making a processing trajectory identical to the target trajectory on the basis of the inverse model of the vibration phenomenon, or a control program based on another range of movement or another maximum acceleration, for example.

As illustrated in FIG. 1, the proposal system 1000 includes a proposal device 100, the working machine 200, a first terminal device 300, a second terminal device 400, and a display device 500. The proposal device 100, the working machine 200, the first terminal device 300, the second terminal device 400, and the display device 500 are connected to a communication network 700, and connected to each other so as to be communicable with each other via the communication network 700. The communication network 700 is also connected to a first server 600A, a second server 600B, and a third server 600C. The first server 600A, the second server 600B, and the third server 600C are hereinafter collectively referred to as “servers 600” as appropriate.

The proposal device 100 proposes an equipment configuration that satisfies the user requests to the user. The proposal device 100 acquires various types of information from various devices connected to the communication network 700, and determines an equipment configuration that satisfies the user requests on the basis of the acquired information. The proposal device 100 in this step refers to information, such as a lineup of optional components of the working machine 200 and a lineup of control programs, which are acquired from the servers 600, and infers a processing accuracy and a processing speed through coupled analysis based on a control model and a mechanism analysis model.

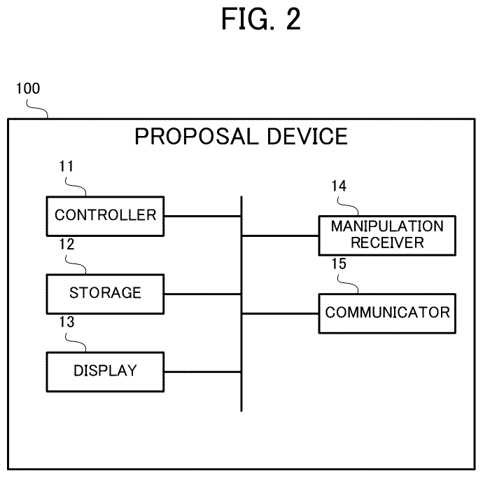

The proposal device 100 causes the display device 500 to display information related to the determined equipment configuration. The proposal device 100 is a cloud server that provides a service for proposing an equipment configuration that satisfies the user requests, for example. Typical cloud servers provide resources in cloud computing. As illustrated in FIG. 2, the proposal device 100 includes a controller 11, a storage 12, a display 13, a manipulation receiver 14, and a communicator 15.

The controller 11 includes a central processing unit (CPU), a read only memory (ROM), a random access memory (RAM), and a real time clock (RTC), for example. The CPU may also be called a central processing unit, central calculation unit, processor, microprocessor, microcomputer, or digital signal processor (DSP), for example. The CPU serves as a central calculation processor that executes processes and calculations related to control of the proposal device 100. The CPU in the controller 11 reads the programs and data stored in the ROM, and performs comprehensive control of the proposal device 100, using the RAM as a work area. A typical example of the RTC is an integrated circuit having a time-keeping function. On the basis of the time information read from the RTC, the CPU can specify the current date and time.

The storage 12 includes a non-volatile semiconductor memory, such as flash memory, erasable programmable ROM (EPROM), or electrically erasable programmable ROM (EEPROM), and serves as a so-called auxiliary storage. The storage 12 stores programs and data to be used in various processes executed by the controller 11. The storage 12 also stores data to be generated or acquired through various processes executed by the controller 11.

The display 13 presents various images under the control of the controller 11. For example, the display 13 presents a screen for receiving various manipulations from the user. The display 13 includes a touch screen or a liquid crystal (LC) display, for example. The manipulation receiver 14 receives various manipulations from the user, and provides the controller 11 with information indicating the contents of the received manipulations. The manipulation receiver 14 includes a touch screen, buttons, or levers, for example.

The communicator 15 communicates with devices, such as the working machine 200, the first terminal device 300, the second terminal device 400, the display device 500, and the servers 600, via the communication network 700, under the control of the controller 11. The communicator 15 has a communication interface for connecting the proposal device 100 to the communication network 700.

The working machine 200 processes objects. The working machine 200 is installed in a factory owned by the user, for example. A typical example of the working machine 200 is a numerical control (NC) working machine capable of processing based on numerical control. The NC working machine operates in accordance with coordinate values that designate a movement of the blade edge of a cutting tool, represented by drill, or a movement of a processed object. That is, the designated coordinate values control the operation of a servomotor, so that the NC working machine causes the blade edge or processed object to move and then processes the object.

The working machine 200 in this embodiment includes mechanism portions that convert rotational movements of motors into parallel displacements, and an operating member, such as cutting tool or laser emitting unit, which moves in three linear directions including two horizontal directions and one vertical direction. The mechanism portions include a linear guide and a rack-and-pinion mechanism, for example. The working machine 200 may include, as the operating member, a rotating member or an arm that holds various objects.

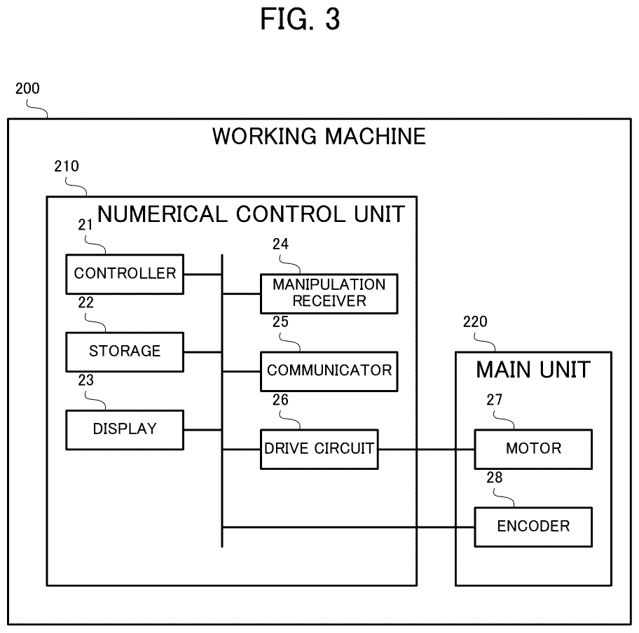

As illustrated in FIG. 3, the working machine 200 includes a numerical control unit 210 and a main unit 220. The numerical control unit 210 provides an instruction indicating a target movement trajectory of the main unit 220 in terms of numerical information. The numerical control unit 210 includes a controller 21, a storage 22, a display 23, a manipulation receiver 24, a communicator 25, and a drive circuit 26. The main unit 220 processes an object, under instructions from the numerical control unit 210. The main unit 220 includes motors 27 and encoders 28.

The controller 21 includes a CPU, a ROM, a RAM, and an RTC, for example. The CPU may also be called a central processing unit, central calculation unit, processor, microprocessor, microcomputer, or DSP, for example. The CPU serves as a central calculation processor that executes processes and calculations related to control of the working machine 200. The CPU in the controller 21 reads the programs and data stored in the ROM, and performs comprehensive control of the working machine 200, using the RAM as a work area.

The storage 22 includes a non-volatile semiconductor memory, such as flash memory, EPROM, or EEPROM, and serves as a so-called auxiliary storage. The storage 22 stores programs and data to be used in various processes executed by the controller 21. The storage 22 also stores data to be generated or acquired through various processes executed by the controller 21.

The display 23 presents various images under the control of the controller 21. For example, the display 23 presents a screen for receiving various manipulations from the user. The display 23 includes a touch screen or an LC display, for example. The manipulation receiver 24 receives various manipulations from the user, and provides the controller 21 with information indicating the contents of the received manipulations. The manipulation receiver 24 includes a touch screen, buttons, or levers, for example.

The communicator 25 communicates with devices, such as the proposal device 100, the first terminal device 300, the second terminal device 400, the display device 500, and the servers 600, via the communication network 700, under the control of the controller 21. The communicator 25 has a communication interface for connecting the working machine 200 to the communication network 700.

The drive circuit 26 drives the motors 27 under the control of the controller 21. The drive circuit 26 feeds pulse signals to the motors 27, under instructions output from the controller 21.

The motors 27 convert electrical energy into mechanical energy. The motors 27 rotate in accordance with the pulse signals fed from the drive circuit 26. The rotation of the motors 27 induces a displacement of the blade edge or processed object. A typical example of the motors 27 is a servomotor.

The encoders 28 are each a sensor that detects a change in the mechanical position and outputs electrical signals indicating a result of the detection. The encoders 28 detect rotational angles of the corresponding motors 27, and feed the controller 21 with electrical signals indicating the detected rotational angles.

The first terminal device 300 is designed to acquire accuracy achievement information indicating a processing accuracy achieved by the working machine 200. The achieved processing accuracy is a value of processing accuracy measured at a representative position of the object processed by the current working machine 200, for example. The first terminal device 300 feeds the acquired accuracy achievement information to the proposal device 100. The first terminal device 300 acquires the accuracy achievement information by a procedure that can be adjusted as appropriate. For example, the first terminal device 300 may acquire the accuracy achievement information indicating a result of measuring a processing accuracy of the processed object from a measurement device for measuring the processing accuracy, or may receive the accuracy achievement information from the user. The first terminal device 300 may be a dedicated device integrated with the measurement device, or may be a general-purpose terminal device, such as smartphone or personal computer. This general-purpose terminal device includes a CPU, a ROM, a RAM, a touch screen, a keyboard, and a communication interface, for example.

The second terminal device 400 is designed to receive user requests for processing performances. A typical example of the second terminal device 400 is a terminal device used by the user of the working machine 200. The second terminal device 400, when receiving user requests for processing performances from the user, feeds information indicating the user requests for processing performances to the proposal device 100. The second terminal device 400 is a general-purpose terminal device, such as smartphone or personal computer, for example.

The display device 500 presents various types of information. The display device 500, when receiving information related to the equipment configuration from the proposal device 100, presents the information related to the equipment configuration. The display device 500 is a general-purpose terminal device, such as smartphone or personal computer, for example.

The servers 600 provide product information indicating at least one of a lineup of components applicable to the working machine 200 or a lineup of control programs applicable to the working machine 200. A typical example of the servers 600 is a cloud server that provides product information in accordance with the user requests. The first server 600A provides product information related to commercial components applicable to the working machine 200. The second server 600B provides product information related to individually customized components applicable to the working machine 200. The third server 600C provides product information related to control programs applicable to the working machine 200. Examples of the commercial components include servomotors and rack-and-pinion mechanisms. Examples of the individually customized components include bed columns and cross rails.

The product information contains various types of information related to each component or control program. For example, the product information may contain drawing data indicating the shape, size, mass, and materials of the component, measurement data indicating measured values of rigidity, friction, and attenuation of the component, and constraint condition data indicating introduction costs, construction period, and conditions for introduction of the component. The drawing data can contribute to confirmation of the compatibility of the component with the current working machine 200. The measurement data can contribute to calculation of vibration characteristics. The constraint condition data can contribute to comparison between the introduction costs and a budget, and comparison between the construction period and an allowable period of deactivation of the working machine 200, for example. The constraint condition data can also contribute to confirmation of constraints of installation environment, such as necessity of reinforcement of the floor, temperature-humidity environment, corrosive environment, and dust-proof and water-proof conditions.

The control program is a program that has a function of executing various corrections while the working machine 200 is operating in accordance with processing trajectory data output from a numerical control program, and thus reducing the error between the trajectory based on the results of encoding by the encoders 28 and the trajectory based on the processing trajectory data. The control program is preferably updated in the working machine 200 as appropriate, so as to be suitable for the individual situations around the user, such as the component configuration of the working machine 200, the installation site of the working machine 200, and the level of deterioration of the working machine 200.

The communication network 700 connects the proposal device 100, the working machine 200, the first terminal device 300, the second terminal device 400, the display device 500, and the servers 600 to each other. A typical example of the communication network 700 is the Internet.

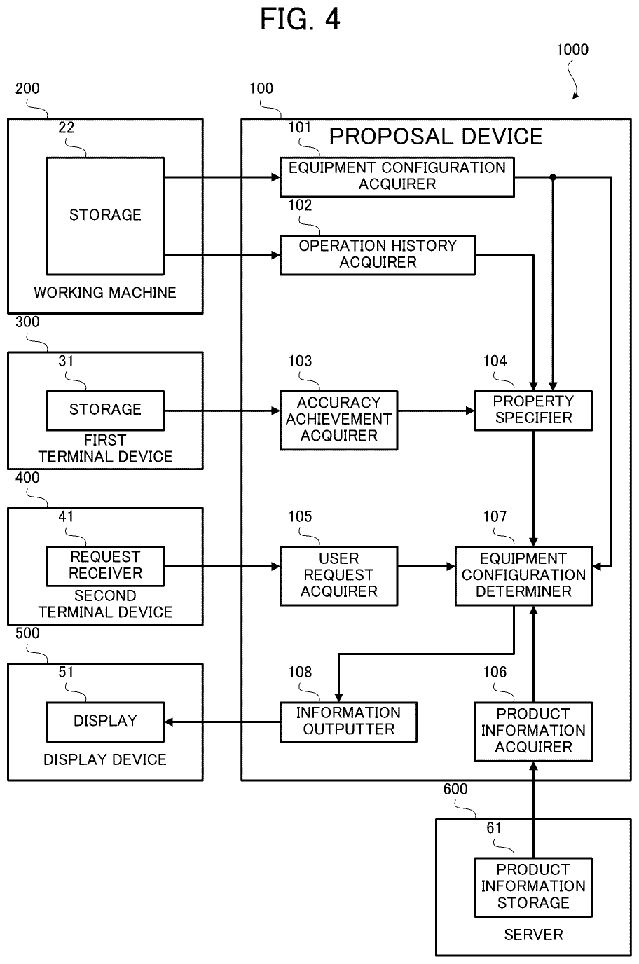

The following describes functions of the proposal system 1000 with reference to FIG. 4. The brief description of the functions of the working machine 200, the first terminal device 300, the second terminal device 400, the display device 500, and the servers 600 are followed by the detailed description of the functions of the proposal device 100.

The working machine 200 has a recording function, a storing function, and a transmitting function, for example. The recording function is aimed at recording operation history information indicating an operation history of the working machine 200. The operation history information indicates a history of signals output from the encoders 28, a history of processing trajectories, a history of the number of times of acceleration, a history of correction signals output from the control program, and a history of parameters used in calculation for correction, for example. The history of signals output from the encoders 28 is a history of measured rotational angles of the motors 27, for example. The history of processing trajectories and the history of the number of times of acceleration can be calculated from the history of signals output from the encoders 28. Alternatively, the history of processing trajectories and the history of the number of times of acceleration may be calculated from images captured by a camera, for example.

The history of output correction signals contains a frequency of occurrence of correction signals and an amount of correction indicated by the correction signals, for example. The history of output correction signals contains chronological data on correction signals for reducing the error between the trajectory based on the results of encoding by the encoders 28 and the trajectory based on the processing trajectory data while the main unit 220 is operating in accordance with the processing trajectory data output by the numerical control program of the numerical control unit 210 to the main unit 220, and contains the number of times of exceedance of the amount of correction over a threshold amount, for example.

The calculation for correction uses parameters, examples of which include moment of inertia, viscous friction, Coulomb friction, and offset load, in the transfer model. The parameters used in calculation for correction are not necessarily parameters of the working machine 200 itself, and may also be a rigidity of the floor or ground provided with the working machine 200, or a temperature in the room accommodating the working machine 200, which affects rubber members and grease, for example. The recording function is achieved by the controller 21 that records information in the storage 22, for example. The recording function may also be achieved by the controller 21 that records information in a storage included in any of various devices connected to the working machine 200 via the communication network 700, for example. The storage 22 is an example of storage means.

The storing function is aimed at storing the operation history information and current equipment configuration information. The current equipment configuration information indicates a current equipment configuration containing a current component configuration of the working machine 200 and a current control program of the working machine 200. The storing function is achieved by the storage 22, for example. The transmitting function is aimed at transmitting the operation history information and the current equipment configuration information to the proposal device 100. The transmitting function is achieved by the controller 21 that controls the communicator 25, for example.

The first terminal device 300 has an acquiring function, a storing function, and a transmitting function, for example. The acquiring function is aimed at acquiring accuracy achievement information indicating a processing accuracy achieved by the working machine 200. The acquiring function is achieved by cooperation of the CPU and the touch screen or the communication interface, for example. The storing function is aimed at storing the accuracy achievement information. The storing function is achieved by a storage 31 including a RAM, for example. The transmitting function is aimed at transmitting the accuracy achievement information to the proposal device 100. The transmitting function is achieved the CPU that controls the communication interface, for example.

The second terminal device 400 has a request receiving function, and a transmitting function, for example. The request receiving function is aimed at receiving user requests for processing performances from the user. The request receiving function is achieved by a request receiver 41 including a touch screen, for example. The transmitting function is aimed at transmitting information related to the user requests to the proposal device 100. The transmitting function is achieved by a CPU that controls a communication interface, for example.

The display device 500 has a displaying function. The displaying function is aimed at displaying the information related to the equipment configuration received by the display device 500 from the proposal device 100. The displaying function is achieved by cooperation of a CPU and a display 51, for example. The display 51 is an example of display means.

The following describes functions of the proposal device 100. The proposal device 100 has functional components including an equipment configuration acquirer 101, an operation history acquirer 102, an accuracy achievement acquirer 103, a property specifier 104, a user request acquirer 105, a product information acquirer 106, an equipment configuration determiner 107, and an information outputter 108. These functions are performed by software, firmware, or a combination of software and firmware. The software and firmware are described in the form of programs, and stored in the ROM or the storage 12. The programs stored in the ROM or the storage 12 are executed by the CPU, and thus perform these functions.

The equipment configuration acquirer 101 acquires current equipment configuration information indicating a current equipment configuration containing a current component configuration of the working machine 200 and a current control program of the working machine 200. The equipment configuration acquirer 101 acquires the current equipment configuration information from the working machine 200, for example. The equipment configuration acquirer 101 may acquire the current equipment configuration information from devices, other than the working machine 200, connected to the proposal device 100 via the communication network 700. The equipment configuration acquirer 101 may also acquire current equipment configuration information preliminarily stored in the storage 12. The equipment configuration acquirer 101 is an example of equipment configuration acquiring means.

The operation history acquirer 102 acquires operation history information indicating an operation history of the working machine 200. The equipment configuration acquirer 101 acquires the operation history information from the working machine 200, for example. The operation history acquirer 102 is an example of operation history acquiring means.

The accuracy achievement acquirer 103 acquires accuracy achievement information indicating a processing accuracy achieved by the working machine 200. The accuracy achievement acquirer 103 acquires the accuracy achievement information from the first terminal device 300, for example. The accuracy achievement acquirer 103 is an example of accuracy achievement acquiring means.

The property specifier 104 specifies an accuracy-related property that is a property affecting the processing accuracy of the working machine 200, on the basis of the current equipment configuration information, the operation history information, and the accuracy achievement information. The accuracy-related property is a parameter indicating the inertia, rigidity, or attenuation property of the components of the working machine 200, the rigidity or attenuation property of the installation site, and the viscous or Coulomb frictions of the driving or sliding members, for example. The property specifier 104 specifies the accuracy-related property through coupled analysis based on the control model and the mechanism analysis model, for example. The property specifier 104 is an example of property specifying means.

The user request acquirer 105 acquires user requests for processing accuracy. The user request acquirer 105 acquires the user requests via the second terminal device 400, for example. The user requests may have any form. For example, the user requests may designate a processing accuracy and a processing speed in terms of values. Alternatively, the user requests may designate a relative priority between the processing accuracy and the processing speed. Specifically, the user requests may designate either a speed-first policy of prioritizing the processing speed over the processing accuracy or an accuracy-first policy of prioritizing the processing accuracy over the processing speed. The user request acquirer 105 is an example of user request acquiring means.

The product information acquirer 106 acquires product information indicating at least one of a lineup of components applicable to the working machine 200 or a lineup of control programs applicable to the working machine 200. For example, the product information acquirer 106 acquires information related to commercial components from the first server 600A, acquires product information related to individually customized components from the second server 600B, and acquires product information related to control programs from the third server 600C. The product information acquirer 106 is an example of product information acquiring means.

The equipment configuration determiner 107 determines a proposed equipment configuration, on the basis of the current equipment configuration information, the accuracy-related property, and the product information. The proposed equipment configuration indicates an equipment configuration that satisfies the user requests and that is the current equipment configuration with at least one of the current component configuration or the current control program being changed. The equipment configuration determiner 107 determines the proposed equipment configuration, by applying the accuracy-related property to the coupled analysis based on the control model and the mechanism analysis model. The equipment configuration determiner 107 is an example of equipment configuration determining means.

The information outputter 108 outputs proposed equipment related information that is information related to the proposed equipment configuration. For example, the information outputter 108 transmits the proposed equipment related information to the display device 500. The proposed equipment related information may be any information related to a proposed equipment configuration. For example, the proposed equipment related information may indicate a proposed equipment configuration, that is, information indicating a proposed component configuration and a proposed control program. Alternatively, the proposed equipment related information may indicate the difference between the current equipment configuration and the proposed equipment configuration, that is, information indicating components to be added or substituted and control programs to be added or substituted. Alternatively, the proposed equipment related information may indicate costs and period required for addition or substitution of the components or control program. The information outputter 108 is an example of information outputting means.

The equipment configuration determiner 107 specifies a first trajectory in the trajectories drawn by a traveling member included in the working machine 200 while the working machine 200 is processing an object. The traveling member is displaced while the working machine 200 is processing an object. The traveling member may be the blade edge for processing the object, or the tip of the arm that holds the object, for example. Examples of the trajectories drawn by the traveling member include rectangular trajectories defined by sequential uniaxial movements, and circular trajectories defined by contemporary biaxial movements. The first trajectory corresponds to a part of the trajectories drawn by the traveling member. The equipment configuration determiner 107 can specify the trajectories drawn by the traveling member on the basis of the current equipment configuration information and the operation history information, for example. The equipment configuration determiner 107 may specify a single first trajectory or multiple first trajectories.

The equipment configuration determiner 107 specifies a first component in the current component configuration that is used when the traveling member draws the first trajectory. The first component is a component in the current component configuration that is used when the traveling member draws the first trajectory. The first component is preferably a component that significantly affects the processing performances. The first component is preferably a component that causes vibration or impairment of the processing accuracy among components used when the traveling member draws the first trajectory, for example. The equipment configuration determiner 107 may specify a single first component or multiple first components.

The equipment configuration determiner 107 determines, as a proposed equipment configuration, an equipment configuration that is the current equipment configuration with a new component applied in place of the first component, or an equipment configuration that is the current equipment configuration with a new component applied in addition to the first component. The new component to be applied in place of the first component has a higher rigidity than the first component and is more capable of suppressing vibration or impairment of the processing accuracy than the first component, for example. The new component to be applied in addition to the first component attenuates the vibration that adversely affects the processing accuracy, for example. The equipment configuration determiner 107 can refer to the lineup of components indicated by the product information, and specify a new component applicable in place of or in addition to the first component, for example.

The equipment configuration determiner 107 may select, as the first trajectory, a frequently drawn trajectory among the trajectories drawn by the traveling member, on the basis of the current equipment configuration information and the operation history information. The component used when the frequently drawn trajectory is drawn is considered to significantly affect the processing performances. The equipment configuration determiner 107 thus preferentially selects the frequently drawn trajectory as the first trajectory.

The equipment configuration determiner 107 may select, as the first trajectory, a trajectory that readily causes vibration or impairment of the processing accuracy among the trajectories drawn by the traveling member, on the basis of the current equipment configuration information and the operation history information. The component used when the trajectory that readily causes vibration or impairment of the processing accuracy is drawn is considered to significantly affect the processing performances. The equipment configuration determiner 107 thus preferentially selects the trajectory that readily causes vibration or impairment of the processing accuracy as the first trajectory.

The equipment configuration determiner 107 refers to the lineup indicated by the product information, and specifies one or more candidate components corresponding to the first component. The candidate components mean candidates of the above-mentioned new component, which are applicable in place of or in addition to the first component. The equipment configuration determiner 107 then determines, as the new component, a candidate component that satisfies the user requests among the specified one or more candidate components.

The equipment configuration determiner 107 specifies a frequency that readily causes vibration, among the frequencies used while the working machine 200 is processing an object. This frequency may be a frequency of control signals for causing the motors 27 to generate torque, or a frequency of rotation of the motors 27. The equipment configuration determiner 107 may specify a frequency that readily causes vibration, from the current component configuration indicated by the current equipment configuration information, for example. The equipment configuration determiner 107 may also specify a frequency that readily causes vibration, from the history of output correction signals indicated by the operation history information.

The equipment configuration determiner 107 determines, as a proposed equipment configuration, an equipment configuration containing a control program provided with a filter for removing a specific frequency component, for example. The equipment configuration determiner 107 selects a control program provided with a filter for removing a specific frequency component, from the lineup of control programs. The selected control program is a program that less readily generates vibration at the above-mentioned frequency, and generates control signals for generation of motor torque excluding acceleration components at the frequency.

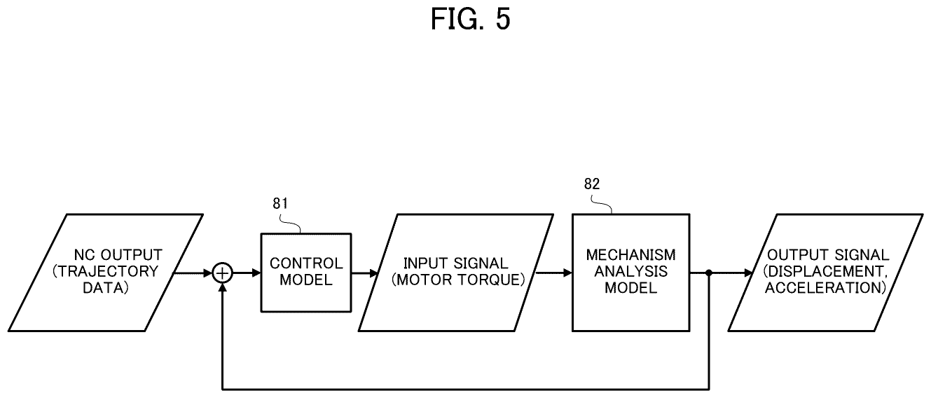

The following describes a method of specifying the accuracy-related property through coupled analysis based on the control model and the mechanism analysis model, and a method of specifying processing performances through the coupled analysis, with reference to FIGS. 5, 6, and 7.

First, on the basis of the current equipment configuration information, the operation history information, and the accuracy achievement information, a trajectory providing an especially low processing accuracy is specified. The processing accuracy corresponds to the difference between the designated NC data on the trajectory of a tip 221 and the measurement data acquired by measuring processed objects. The processing accuracy can be calculated from pieces of measurement data acquired by measuring several processed objects. In general, the processed objects are subject to shipping inspections to obtain measurement data, which can be applied to calculation of the processing accuracy. In this embodiment, one or more trajectories are selected as targets of improvement of the processing accuracy. The number of selected trajectories is preferably at most three to five, because a larger number of selected trajectories needs higher costs of calculation. In the case where no measurement data is provided, a trajectory that has been corrected many times or a trajectory that has received a large correction can be selected as the above-mentioned trajectory, on the basis of the operation history of the control program of the working machine 200, for example.

As illustrated in FIG. 5, the method uses a control model 81. The control model 81 receives input of NC trajectory data, which is designated NC data on a trajectory, and input of feedback data on the rotational angles and the angular accelerations of the motors 27. The control model 81 is adjusted so as to reduce the difference between the NC trajectory data and the trajectory data indicating a trajectory of the tip 221 in a mechanism analysis model 82. The control model 81 generates signals for motor torque on the basis of the NC trajectory data. The control model 81 employs a control method, a typical example of which is an open-loop control method that involves adjusting control parameters, such as proportional gain, integral gain, and differential gain, and establishing a transfer function. The motor torque generated by the control model 81 is fed to the mechanism analysis model 82 that simulates the main unit 220 of the working machine 200. The mechanism analysis model 82 can be analyzed to infer a processing accuracy and a processing speed.

The processing accuracy acquired through the coupled analysis corresponds to the difference between the designated NC data on the trajectory of the tip 221 and the data on the simulated trajectory of the tip 221 depicted in the analysis. The processing accuracy is affected by vibration or attenuation caused by deformation of a member having a low rigidity or a junction, and a variation in movements of the driving members or sliding members 225 because of their rigidities, attenuation properties, Coulomb frictions, and viscous frictions, for example, during operation of the working machine 200. The properties of these effect factors may be affected by the magnitudes of torque of the motors, the levels of inertia of the driving members and the operating members, and a variation in the positions or orientations of the operating members. The processing speed acquired through coupled analysis is a time required for processing of an object in simulation of the operation of the working machine 200 in the analysis of the trajectory data. The processing speed is lowered when the control program defines the upper limit of acceleration to improve the processing accuracy, or is provided with a filter for removing a specific frequency component.

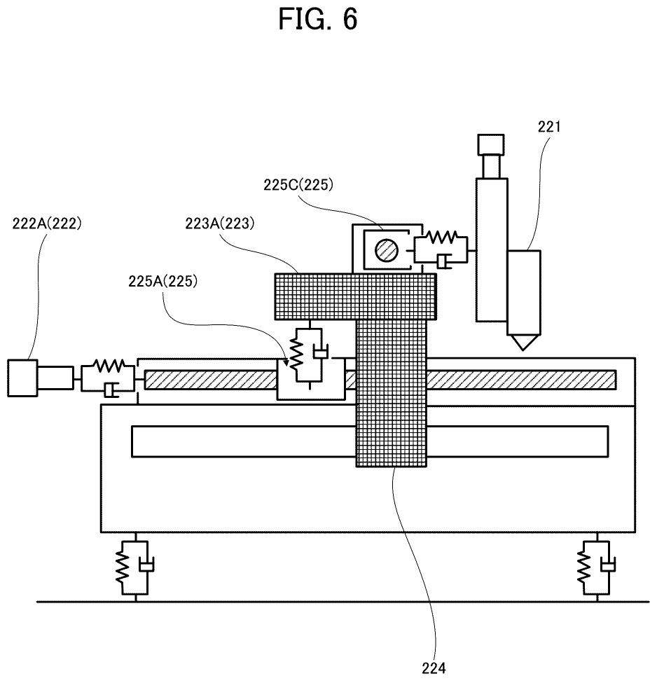

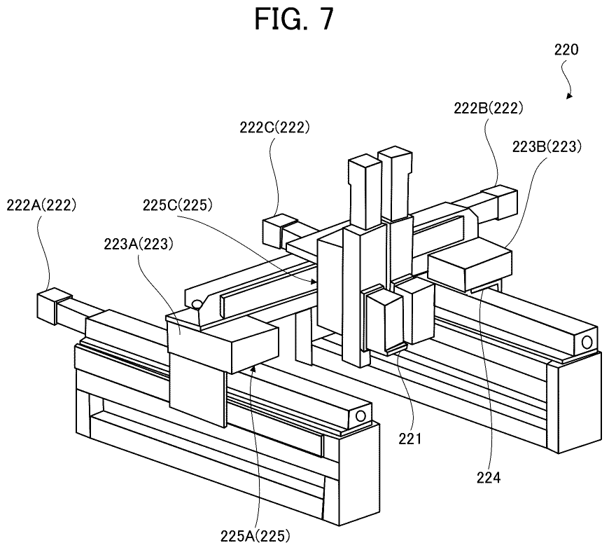

As illustrated in FIG. 6, the mechanism analysis model 82 regards a part or all of the main unit 220 of the working machine 200 as elastic members. The portions regarded as elastic members are emphasized by crosshatching in FIG. 6. The mechanism analysis model 82 defines parameters, such as inertia, rigidity, attenuation, friction, and viscosity, for each of the components and junctions, and can thus simulate minute vibration that affects the processing accuracy. The parameters defined by the mechanism analysis model 82 correspond to the accuracy-related properties. FIG. 7 illustrates the main unit 220 simulated in the mechanism analysis model 82.

The main unit 220 includes the tip 221, a motor member 222A, a motor member 222B, a motor member 222C, a component 223A, a component 223B, a component 224, a sliding member 225A, and a sliding member 225C. The motor member 222A, the motor member 222B, and the motor member 222C are hereinafter collectively referred to as “motor members 222”, the component 223A and the component 223B are collectively referred to as “components 223”, and the sliding member 225A and the sliding member 225C are collectively referred to as “sliding members 225”, as appropriate.

The tip 221 is a member that processes an object, and corresponds to the blade edge, for example. The motor members 222 correspond to the motors 27. The components 223 and the component 224 cause elastic deformation or elastic vibration due to a force of inertia or a moment of inertia when the motor members 222 drive the tip 221 during operation of the working machine 200, and thus affect the accuracy of the tip 221. The components 223 and the component 224 are thus regarded as elastic members. The components other than the components 223 and the component 224 are regarded as elastic members or rigid members in accordance with the same principle.

The driving members that transfer the torque or force from the motor members 222 to the components 223 serving as movable members, and the sliding members 225 that guide the components 223 are simulated by model elements representing properties, such as rigidities, attenuation properties, frictions, and viscosities. For example, elastic deformation of components, such as linear guides or ball screws, are defined as spring elements, having certain rigidities and attenuation properties of a translational spring and a rotational spring. The viscous frictions of gear portions of the components, such as linear guides and ball screws, are defined as resisting forces proportional to the speed. These parameters, such as rigidities, frictions, and viscosities, may be measured from the real object or inferred from a similar object. In the case where no real object is provided, the parameters, such as rigidities, frictions, and viscosities, may be calculated from the relationship between load and displacement or the relationship between speed and viscosity, through structural analysis or fluid analysis, for example. In the case where the properties are non-linear, non-linear spring properties, non-linear friction properties, or non-linear viscosity properties may be defined instead of the linear elements.

In specific, a member that causes multiple modes of vibration is simulated as an elastic model by a finite element method that can reproduce three-dimensional deformation. For example, the components 223 and the component 224 correspond to the bases of the movable members, and cause a combination of vibration substantially in horizontal directions and vibration substantially in rotational directions. The components 223 and the component 224 are thus simulated as elastic models by the finite element method. Components, such as cables and accessories, which do not affect the rigidity, are defined as mass points having masses alone, so that the model can simulate the mass and the center of gravity of the entire working machine 200.

The control model 81 inputs, into the mechanism analysis model 82, a value of motor torque that follows the designated trajectory data, at a time interval associated with the control cycle. The mechanism analysis model 82 analyzes movements of the movable members, such as the tip 221, the components 223, and the component 224, and elastic deformation of the model of the entire working machine 200, in response to input of the motor torque. The mechanism analysis model 82 feeds sensor signals, such as signals indicating rotational angles and angular rates of the motors 27, back to the control model 81, at a time interval associated with the control cycle. This configuration can reproduce the operation equivalent to the operation of the actual working machine 200, through coupled analysis based on the control model 81 and the mechanism analysis model 82. This embodiment is directed to inference of a processing accuracy and a processing speed of the working machine 200 through the coupled analysis.

The method in this embodiment involves specifying accuracy-related properties, which indicate the rigidity of the installation site of the working machine 200 and the levels of deterioration of the individual components, on the basis of the difference between the processing accuracy acquired through the coupled analysis and the actual processing accuracy of the working machine 200. The accuracy-related properties are affected by variations in individual working machines 200, variations in places of installation, changes in conditions of use, changes in environment, and changes with time, for example. The specification of the accuracy-related properties can thus lead to improvement of the accuracy of inferring a processing accuracy and a processing speed. The processing accuracy and the processing speed of a new piece of equipment, which has an equipment configuration that is the current equipment configuration with a component or control program being changed, can be inferred through coupled analysis based on the substituted component or control program on the basis of the acquired accuracy-related properties.

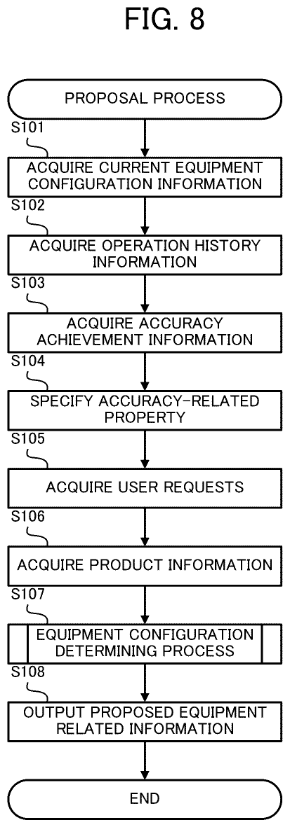

The following describes a proposal process executed by the proposal device 100, with reference to the flowchart of FIG. 8. The proposal device 100 executes the proposal process, and thus achieves a proposal method. The proposal process may be executed in response to reception of an instruction to start the proposal process from the user at the second terminal device 400, or executed at regular intervals (for example, every couple of months), for example.

The controller 11 of the proposal device 100 first acquires current equipment configuration information (Step S101). For example, the controller 11 acquires current equipment configuration information from the working machine 200. The controller 11, after completion of Step S101, acquires operation history information (Step S102). For example, the controller 11 acquires operation history information from the working machine 200. The working machine 200 during operation accumulates information indicating a history of operation in the storage 22 in the form of operation history information.

The controller 11, after completion of Step S102, acquires accuracy achievement information (Step S103). For example, the controller 11 acquires accuracy achievement information from the first terminal device 300. The first terminal device 300 accumulates information indicating the accuracies of processed objects in the storage 31 in the form of accuracy achievement information, after every measurement of the accuracy of a processed object fabricated by the working machine 200, for example.

The controller 11, after completion of Step S103, specifies the accuracy-related property (Step S104). Specifically, the controller 11 specifies the accuracy-related property through coupled analysis, on the basis of the current equipment configuration information, the operation history information, and the accuracy achievement information. The accuracy-related property is a property that affects the processing accuracy of the working machine 200, and mainly affects vibration of the working machine 200 and impairment of the processing accuracy, for example. The controller 11 specifies levels of friction of the driving members of the main unit 220, levels of rigidity of the components and their junctions of the main unit 220, and levels of attenuation of vibration at the components and their junctions of the main unit 220, for example. The controller 11 may also infer the accuracy-related property for each of the positions and orientations of the movable members, on the basis of a variation in processing accuracy caused by the positions and orientations of the movable members.

The controller 11, after completion of Step S104, acquires user requests (Step S105). For example, the controller 11 acquires user requests for processing performances via the second terminal device 400. The user requests contain a required processing accuracy, which is the processing accuracy required by the user, and a required processing speed, which is the processing speed required by the user, for example. The controller 11, after completion of Step S105, acquires product information (Step S106). For example, the controller 11 acquires product information related to commercial components from the first server 600A, acquires product information related to individually customized components from the second server 600B, and acquires product information related to control programs from the third server 600C.

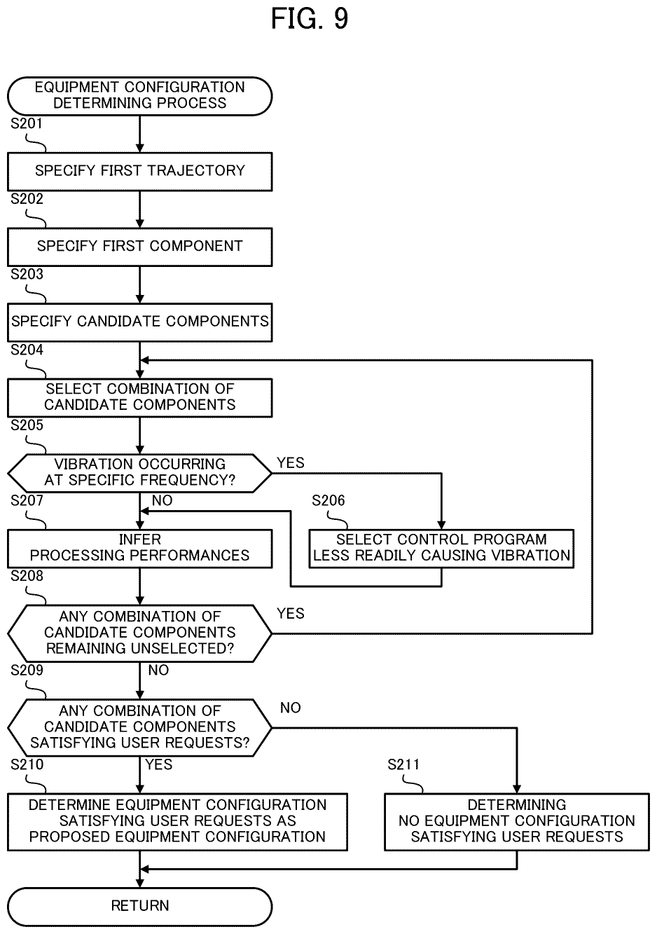

The controller 11, after completion of Step S106, executes an equipment configuration determining process (Step S107). The equipment configuration determining process is described in detail below, with reference to the flowchart of FIG. 9. The equipment configuration determining process is aimed at selecting, as a new equipment configuration to be proposed to the user, a component configuration and a control program that satisfy the user requests, from the lineups indicated by the product information.

The controller 11 first specifies a first trajectory (Step S201). The first trajectory corresponds to a part of the trajectories drawn by the traveling member included in the working machine 200 while the working machine 200 is processing an object. The first trajectory is a frequently drawn trajectory or a trajectory that readily causes vibration, for example. The controller 11 specifies one or more first trajectories.

The controller 11, after completion of Step S201, specifies a first component (Step S202). The first component is used when the traveling member draws the first trajectory in the current component configuration. The first component significantly affects vibration and the processing accuracy, for example. The controller 11 specifies one or more first components for each of the one or more first trajectories.

The controller 11, after completion of Step S202, specifies candidate components (Step S203). The candidate components are applicable in place of or in addition to the first component. The controller 11 specifies one or more candidate components for each of the one or more first components.

The controller 11, after completion of Step S203, selects a combination of candidate components (Step S204). The controller 11 selects at least one candidate component to be substituted or added. For example, the controller 11 selects at least one first component among the specified one or more first components. The controller 11 refers to the lineup of components indicated by the product information, and selects a candidate component to be applied in place of or in addition to each of the selected at least one first component.

The controller 11, after completion of Step S204, determines whether vibration occurs at a specific frequency (Step S205). For example, the controller 11 determines whether vibration larger than predetermined reference vibration occurs at a specific frequency in the equipment configuration containing the component configuration generated by applying the combination of the selected candidate components to the current component configuration indicated by the current equipment configuration information, and the current control program indicated by the current equipment configuration information.

The controller 11, when determining that vibration occurs at a specific frequency (Step S205: YES), selects a control program that less readily causes vibration (Step S206). For example, the controller 11 selects a control program that less readily causes vibration at the specific frequency, from the lineup of control programs indicated by the product information. The selected control program may be applied in place of or in addition to the current control program.

The controller 11, when determining that no vibration occurs at a specific frequency (Step S205: NO), or after completion of Step S206, infers processing performances (Step S207). Specifically, the controller 11 infers a processing accuracy and a processing speed by executing the coupled analysis, for the equipment configuration generated by applying the combination of the selected candidate components and the selected control program to the current equipment configuration.

The controller 11, after completion of Step S207, determines whether any combination of candidate components remains unselected (Step S208). The controller 11, when determining that any combination of candidate components remains unselected (Step S208: YES), returns to Step S204, and infers processing performances for an equipment configuration generated by applying another combination of currently selected candidate components.

The controller 11, when determining that no combination of candidate components remains unselected (Step S208: NO), determines whether any combination of candidate components satisfies the user requests (Step S209). That is, the controller 11 determines whether any of the combinations of the selected candidate components corresponds to an equipment configuration that satisfies the user requests. The equipment configuration that satisfies the user requests provides an inferred processing accuracy equal to or higher than the required processing accuracy and an inferred processing speed equal to or higher than the required processing speed.

The controller 11, when determining that any combination of candidate components satisfies the user requests (Step S209: YES), determines the equipment configuration that satisfies the user requests to be a proposed equipment configuration (Step S210). In the case of multiple combinations of candidate components satisfy the user requests, the controller 11 determines at least one of the equipment configurations that satisfy the user requests to be the proposed equipment configuration.

The controller 11, when determining that no combination of candidate components satisfies the user requests (Step S209: NO), determines that no equipment configuration satisfies the user requests (Step S211). The controller 11, after completion of Step S210 or S211, terminates the equipment configuration determining process.

The controller 11, after completion of the equipment configuration determining process in Step S107, outputs proposed equipment related information (Step S108). For example, the controller 11 transmits proposed equipment related information to the display device 500, via the communicator 15. The proposed equipment related information is information associated with at least one piece of proposed equipment. The proposed equipment related information is information that indicates components to be introduced, a control program to be introduced, an inferred processing accuracy, an inferred processing speed, and a period and costs of introduction, for each piece of proposed equipment, for example.

When no equipment configuration satisfies the user requests, the controller 11 may transmit, to the display device 500, information indicating no equipment configuration that satisfies the user requests, or information indicating a suggestion of lowering the level of the user requests, for example. In response to reception of the proposed equipment related information from the proposal device 100, the display device 500 causes the display 51 to display various contents indicated by the proposed equipment related information. The controller 11, after completion of Step S108, terminates the proposal process.

This embodiment involves determining a proposed equipment configuration that satisfies the user requests and that is the current equipment configuration with at least one of the current component configuration or the current control program being changed, on the basis of the current equipment configuration information, the accuracy-related property, and the product information. The present disclosure can therefore achieve proposal of an equipment configuration of a working machine that complies with the user requests including a request for processing accuracy.

The embodiment involves proposing an equipment configuration containing a new component corresponding to the first component used when the traveling member draws a first trajectory selected from the trajectories. In this embodiment, the first component to subject to replacement or addition is specified on the basis of a history of the trajectories drawn by the traveling member included in the working machine 200, that is, a history of use of the working machine 200. The embodiment can thus achieve proposal of an equipment configuration suitable for the status of use of the working machine 200. In an exemplary case where the working machine 200 in this embodiment includes many components that readily vibrate, proposed is an equipment configuration generated by substituting a new component for a frequently used component among the components that readily vibrates. This configuration can avoid proposal of an equipment configuration generated by substituting a new component for a component that readily vibrates but is rarely used, for example.

In principle, the optimum equipment configuration that satisfies the user requests can be inferred by substituting a new component and a new control program for every combination of all the components and all the control programs contained in the current equipment configuration. The method of inferring processing performances of all the combinations through coupled analysis, however, requires an extremely high processing load and long processing period. This method is predicted to involve significant changes in the equipment configuration caused by many changes in the components and control program, resulting in an extremely high costs and long period for these changes in the equipment configuration. In contrast, this embodiment employs a method of efficiently proposing an equipment configuration that satisfies the user requests by changing only the components that are related to the trajectory and that have been used.

In this embodiment, a frequently drawn trajectory is selected as a first trajectory among the trajectories drawn by the traveling member. The embodiment can thus achieve efficient proposal of an equipment configuration that satisfies the user requests.

In this embodiment, a trajectory that readily causes vibration is selected as a first trajectory among the trajectories drawn by the traveling member. The embodiment can thus achieve efficient proposal of an equipment configuration that satisfies the user requests.

In this embodiment, a candidate component that satisfies the user requests is specified among the one or more candidate components specified from the lineup indicated by the product information. The embodiment can thus achieve proposal of an appropriate component to satisfy the user requests.

In this embodiment, a frequency that readily causes vibration is specified, followed by proposal of an equipment configuration containing a control program not associated with the specified frequency. The embodiment can thus achieve proposal of an equipment configuration that satisfies the user requests in the case where the user requests cannot be satisfied by just changing in the component configuration.

The above-described Embodiment 1 may be varied and revised into various modifications. The modifications may employ any of the configurations, functions, and operations described in Embodiment 1. The modifications may also employ configurations, functions, and operations other than the above-described configurations, functions, and operations. The configurations, functions, and operations described in Embodiment 1 may be combined with each other in any manner.

### Embodiment 2

For example, the proposal device 100 may acquire various types of information from devices other than the exemplary devices described in Embodiment 1. The proposal device 100 may acquire current equipment configuration information or operation history information from any of the first terminal device 300, the second terminal device 400, the display device 500, and the servers 600, for example. The proposal device 100 may acquire accuracy achievement information from any of the working machine 200, the second terminal device 400, the display device 500, and the servers 600, for example. The proposal device 100 may acquire user requests from any of the working machine 200, the first terminal device 300, the display device 500, and the servers 600, for example. The proposal device 100 may also acquire user requests via the manipulation receiver 14. The proposal device 100 may transmit proposed equipment related information to the devices, such as the working machine 200, the first terminal device 300, and the second terminal device 400, and cause these devices to display the proposed equipment related information. The proposal device 100 may also cause the display 13 to display the proposed equipment related information.

The proposal system 1000 may have a configuration other than the exemplary configuration described in Embodiment 1. For example, at least two of the devices including the working machine 200, the first terminal device 300, the second terminal device 400, and the display device 500 may be integrated with each other in the proposal system 1000. The proposal system 1000 may lack the second terminal device 400 and the display device 500, and the first terminal device 300 may have functions of the second terminal device 400 and the functions of the display device 500, for example.

### Embodiment 3

Embodiment 1 is directed to an example in which the user activates the working machine 200 after delivery of the working machine 200, and then designates a required processing accuracy and a required processing speed. Alternatively, the user may designate a required processing accuracy and a required processing speed at the timing of order of the working machine 200. In this case, the user may be provided with an equipment configuration that satisfies the user requests, which is based on the installation environment of the working machine 200 inferred from an installation environment of another existing working machine similar to the working machine 200. This configuration can achieve specification of an equipment configuration customized to be suitable for a way of using the working machine 200 or an installation environment of the working machine 200, without the working machine 200. The configuration is therefore expected to contribute to an increase in accuracy, an increase in speed, and a decrease in maintenance costs, for example.

### Embodiment 4

Embodiment 1 is directed to an example in which the working machine 200 is connected to the communication network 700. The working machine 200, however, is not necessarily connected to the communication network 700. In this case, the working machine 200 is designated to lock or unlock various functions at a software update, for example.

The functions of the working machine 200 may be offered by subscription, so that the user can use only a required function when necessary, or try an unfamiliar function.

### Embodiment 5

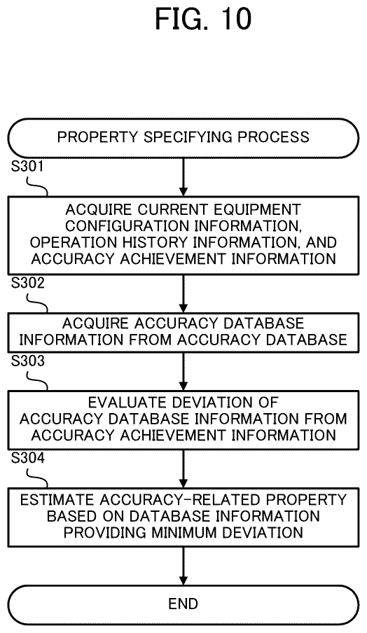

FIG. 10 is a flowchart illustrating a property specifying process executed by a proposal device 100 according to Embodiment 5. The property specifying process is aimed at specifying the accuracy-related property, and corresponds to Steps S101 to S104 in FIG. 8 according to Embodiment 1. In Embodiment 1, the proposal device 100 specifies the accuracy-related property through coupled analysis. The coupled analysis, however, involves simultaneous execution of two types of analysis including analysis of a control model and analysis of a mechanism analysis model, and thus requires a large scale of calculation and suffers from a high processing load. In view of this problem, the proposal device 100 in this embodiment specifies the accuracy-related property on the basis of accuracy database information in the property specifying process.

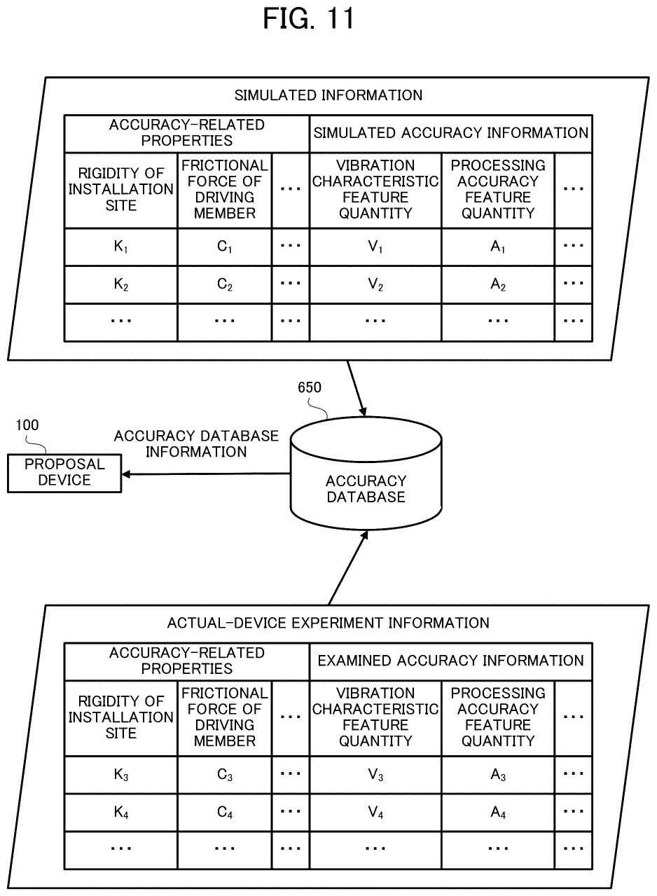

The accuracy database information indicates a correlation between accuracy-related properties and feature quantities related to processing accuracy. As illustrated in FIG. 11, the proposal device 100 can acquire accuracy database information from the accuracy database 650. Examples of the feature quantities related to processing accuracy include a vibration characteristic feature quantity, which is a feature quantity related to the frequency response of the vibration response, and a processing accuracy feature quantity, which is a feature quantity related to a phenomenon, such as overshoot or quadrant glitch. The accuracy database information contains at least one of simulation information or actual-device experiment information. The simulation information contains simulated accuracy information acquired through coupled analysis conducted with variation in the accuracy-related property. The simulated accuracy information indicates a result of simulation of feature quantities related to processing accuracy.

The actual-device experiment information contains examined accuracy information acquired through an experiment performed using an actual device with variation in the accuracy-related property. The examined accuracy information indicates an experimental result of an experiment regarding a feature quantity related to processing accuracy using an actual device. In the property specifying process, the proposal device 100 evaluates a deviation of the accuracy database information from the accuracy achievement information for each accuracy-related property, and specifies the accuracy database information that is minimum in the deviation to be the accuracy-related property of the working machine 200.

The controller 11 of the proposal device 100 first acquires current equipment configuration information, operation history information, and accuracy achievement information (Step S301). The controller 11, after completion of Step S301, acquires accuracy database information from the accuracy database 650 (Step S302). The controller 11, after completion of Step S302, evaluates deviations of the accuracy database information from the accuracy achievement information (Step S303).

Specifically, the controller 11 calculates a deviation of the feature quantity indicated by the accuracy database information from the feature quantity indicated by the accuracy achievement information, for each of parameter values each indicating the accuracy-related property. The deviation means the difference of a certain value from the reference value. The reference value corresponds to the feature quantity indicated by the accuracy achievement information, and the certain value corresponds to the feature quantity indicated by the accuracy database information. Examples of the feature quantity indicated by the accuracy achievement information include a vibration characteristic feature quantity and a processing accuracy feature quantity indicated by the accuracy achievement information acquired regarding the working machine 200. Examples of the feature quantity indicated by the accuracy database information include a vibration characteristic feature quantity and a processing accuracy feature quantity indicated by the simulated accuracy information or the examined accuracy information. The controller 11 calculates a deviation of the feature quantity indicated by the simulated accuracy information or the examined accuracy information for each of the above-mentioned parameter values, from the reference value or the feature quantity indicated by the accuracy achievement information.

The controller 11, after completion of Step S303, infers the accuracy-related property, on the basis of the accuracy database information that is minimum in the deviation (Step S304). In an exemplary case where the accuracy database information contains simulation information, the controller 11 specifies the feature quantity providing the minimum deviation, among the feature quantities indicated by the simulated accuracy information, from the feature quantities indicated by the accuracy achievement information. The controller 11 then infers the parameter value corresponding to the specified feature quantity to be a parameter value indicating the accuracy-related property of the working machine 200.

The following assumes an example in which the accuracy achievement information indicates a vibration characteristic feature quantity of V₀ and indicates a processing accuracy feature quantity of A₀. The simulated accuracy information indicates a vibration characteristic feature quantity of V₁ and a processing accuracy feature quantity of A₁, for parameter values (rigidity of the installation site: K₁, frictional force of the driving member: C₁). The simulated accuracy information indicates a vibration characteristic feature quantity of V₂ and a processing accuracy feature quantity of A₂, for parameter values (rigidity of the installation site: K₂, frictional force of the driving member: C₂). In the case of the difference between V₀ and V₁ smaller than the difference between V₀ and V₂ and the difference between A₀ and A₁ smaller than the difference between A₀ and A₂, the parameter values (rigidity of the installation site: K₁, frictional force of the driving member: C₁) provide the minimum deviations of the feature quantities. The controller 11 thus infers the parameter values (rigidity of the installation site: K₁, frictional force of the driving member: C₁) to be parameter values indicating the accuracy-related properties of the working machine 200.

In another exemplary case where the accuracy database information contains actual-device experiment information, the controller 11 specifies the feature quantity providing the minimum deviation, among the feature quantities indicated by the examined accuracy information, from the feature quantities indicated by the accuracy achievement information. The controller 11 then infers the parameter value corresponding to the specified feature quantity to be a parameter value indicating the accuracy-related property of the working machine 200.

The following assumes an example in which the accuracy achievement information indicates a vibration characteristic feature quantity of V₀ and indicates a processing accuracy feature quantity of A₀. The examined accuracy information indicates a vibration characteristic feature quantity of V₃ and a processing accuracy feature quantity of A₃, for parameter values (rigidity of the installation site: K₃, frictional force of the driving member: C₃). The examined accuracy information indicates a vibration characteristic feature quantity of V₄ and indicates a processing accuracy feature quantity of A₄, for parameter values (rigidity of the installation site: K₄, frictional force of the driving member: C₄). In the case of the difference between V₀ and V₃ smaller than the difference between V₀ and V₄ and the difference between A₀ and A₃ smaller than the difference between A₀ and A₄, the parameter values (rigidity of the installation site: K₃, frictional force of the driving member: C₃) provide the minimum deviations of the feature quantities. The controller 11 thus infers the parameter values (rigidity of the installation site: K₃, frictional force of the driving member: C₃) to be parameter values indicating the accuracy-related properties of the working machine 200. The controller 11, after completion of Step S304, terminates the property specifying process.

As described above, in this embodiment, the accuracy-related property of the working machine 200 is inferred from a correlation between the accuracy-related property and at least one of the vibration characteristic feature quantity or the processing accuracy feature quantity, on the basis of the accuracy achievement information acquired regarding the working machine 200 and the accuracy database information acquired from the accuracy database 650. The embodiment can thus achieve inference of the accuracy-related property with a low processing load. The inference of the accuracy-related property can achieve improved accuracy by continuously adding accuracy database information in the accuracy database 650.

### Embodiment 6

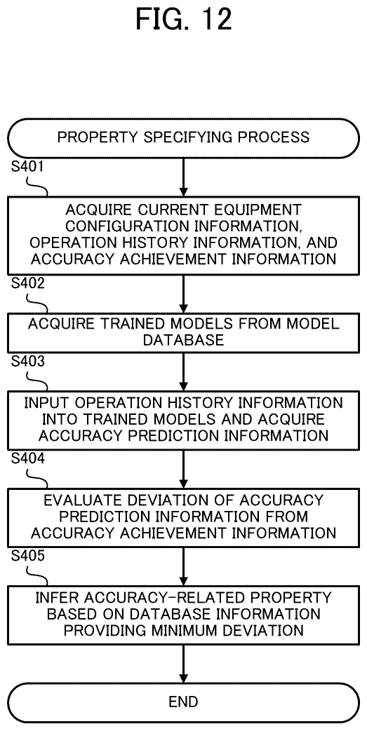

FIG. 12 is a flowchart illustrating a property specifying process executed by a proposal device 100 according to Embodiment 6. In Embodiment 5, at least one of the vibration characteristic feature quantity or the processing accuracy feature quantity serves as an indicator for evaluation of the deviation. This configuration may result in erroneous inference of the accuracy-related property different from the actual accuracy-related property, if the feature quantities are identical by chance. In view of this problem, the proposal device 100 in this embodiment refers to a database of trained model corresponding to the accuracy-related property, and infers the accuracy-related property.

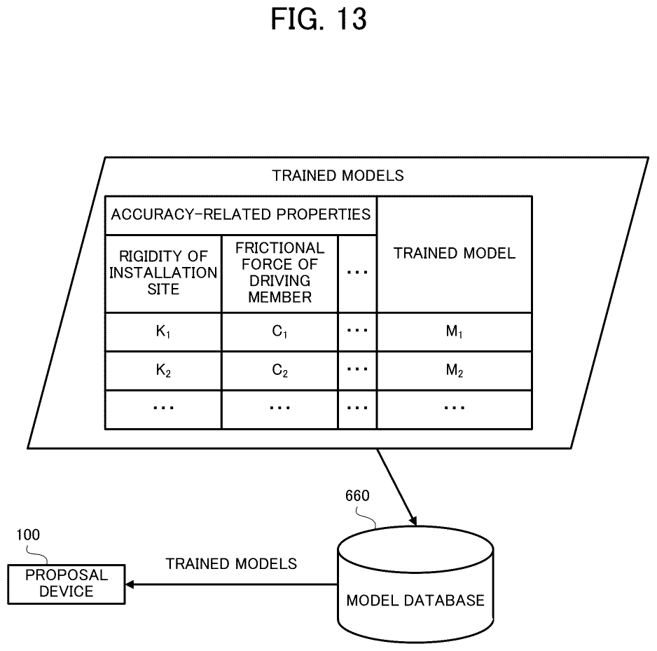

The trained model receives input of operation history information and outputs accuracy prediction information. The accuracy prediction information indicates feature quantities related to processing accuracy. For example, the accuracy prediction information may be a movement trajectory corresponding to the processing accuracy, or a processing accuracy feature quantity of a phenomenon, such as overshoot or quadrant glitch. The trained model is established by learning outputs of movement trajectories of the tip 221 in the mechanism analysis model 82 in response to input of pieces of trajectory data under different conditions, and values of torque fed to the motors under different conditions, for example. A typical example of the trained model is a surrogate model established by learning experiment data, results of analysis of the mechanism analysis model alone, or results of coupled analysis based on a control model and the mechanism analysis model. The proposal device 100, in the property specifying process, inputs operation history information into trained models each established for a corresponding accuracy-related property, and thus acquires accuracy prediction information. As illustrated in FIG. 13, the proposal device 100 can acquire the trained models from a model database 660.

The controller 11 first acquires current equipment configuration information, operation history information, and accuracy achievement information (Step S401). The controller 11, after completion of Step S401, acquires trained models from the model database 660 (Step S402). The controller 11, after completion of Step S402, inputs the operation history information into the trained models, and thus acquires accuracy prediction information (Step S403). Specifically, the controller 11 inputs the operation history information into each of the trained models each established for the corresponding accuracy-related property, and thus acquires accuracy prediction information from the individual trained models.

The controller 11, after completion of Step S403, evaluates a deviation of the accuracy prediction information from the accuracy achievement information (Step S404). Specifically, the controller 11, for the individual pieces of predicated accuracy information acquired from the trained models, calculates a deviation of the feature quantity indicated by the accuracy prediction information from the feature quantity indicated by the accuracy achievement information.

The controller 11, after completion of Step S404, estimates the accuracy-related property, on the basis of the database information that is minimum in the deviation (Step S405). For example, the controller 11 specifies the trained model that has output the accuracy prediction information indicating the feature quantity providing the minimum deviation from the feature quantity indicated by the accuracy achievement information. The controller 11 infers the parameter value corresponding to the specified trained model, to be a parameter value indicating the accuracy-related property of the working machine 200.

The following assumes an example in which the accuracy achievement information indicates a feature quantity of B₀. A trained model M₁ is prepared for parameter values (rigidity of the installation site: K₁, frictional force of the driving member: C₁), and a trained model M₂ is prepared for parameter values (rigidity of the installation site: K₂, frictional force of the driving member: C₂). In response to input of the operation history information acquired regarding the working machine 200, the trained model M₁ outputs accuracy prediction information indicating a feature quantity of B₁, and the trained model M₂ outputs accuracy prediction information indicating a feature quantity of B₂. In the case of the difference between B₀ and B₁ smaller than the difference between B₀ and B₂, the parameter values (rigidity of the installation site: K₁, frictional force of the driving member: C₁) provide the minimum deviation of the feature quantity. The controller 11 thus infers the parameter values (rigidity of the installation site: K₁, frictional force of the driving member: C₁) to be parameter values indicating the accuracy-related property of the working machine 200. The controller 11, after completion of Step S405, terminates the property specifying process.

As described above, in this embodiment, the accuracy-related property of the working machine 200 is inferred on the basis of the accuracy prediction information output from the trained model in the property specifying process. The embodiment can thus achieve inference of the accuracy-related property with improved accuracy.

### Embodiment 7

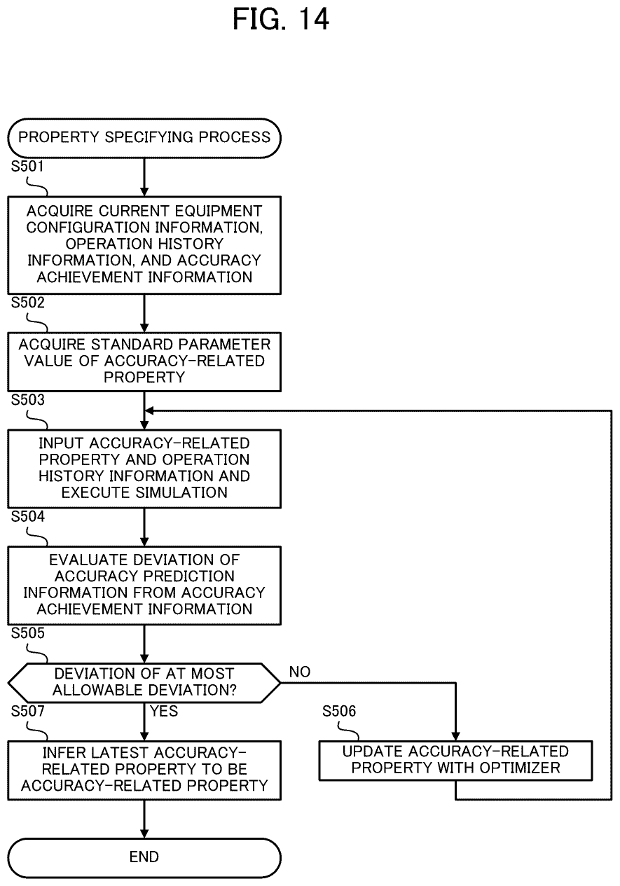

FIG. 14 is a flowchart illustrating a property specifying process executed by a proposal device 100 according to Embodiment 7. In Embodiment 5, if the accuracy database information contains only few patterns of the accuracy-related property or contains only biased patterns, the accuracy database information may contain no patterns of the accuracy-related property providing a deviation smaller than an allowable deviation. In view of this problem, the proposal device 100 in this embodiment acquires a standard parameter value of the accuracy-related property, and executes coupled analysis using the standard parameter value.

The proposal device 100 evaluates a deviation of the accuracy prediction information acquired through coupled analysis, from the accuracy achievement information. When the deviation is an allowable deviation or smaller, the proposal device 100 regards the accuracy-related property to be identical to that of the actual device, and terminates the process of specifying the accuracy-related property. When the deviation exceeds the allowable deviation, the proposal device 100 repeats a series of processes that involve updating the accuracy-related property with an optimizer and executing coupled analysis again. The optimizer can employ an algorithm, examples of which include the particle swarm optimization algorithm and the Bayesian optimization algorithm.

The controller 11 first acquires current equipment configuration information, operation history information, and accuracy achievement information (Step S501). The controller 11, after completion of Step S501, acquires a standard parameter value of the accuracy-related property (Step S502). The controller 11, after completion of Step S502, inputs the accuracy-related property and the operation history information, and executes simulation (Step S503). That is, the controller 11 sets the acquired standard parameter value as the initial value of the accuracy-related property, executes coupled analysis based on the standard parameter value indicating the accuracy-related property and the operation history information, and acquires accuracy prediction information. The accuracy prediction information indicates a feature quantity related to processing accuracy. For example, the accuracy prediction information may be a movement trajectory corresponding to the processing accuracy, or a processing accuracy feature quantity of a phenomenon, such as overshoot or quadrant glitch.

The controller 11, after completion of Step S503, evaluates a deviation of the accuracy prediction information from the accuracy achievement information (Step S504). That is, the controller 11 calculates a deviation of the feature quantity indicated by the accuracy prediction information from the feature quantity indicated by the accuracy achievement information. The controller 11, after completion of Step S504, determines whether the deviation is at most the allowable deviation (Step S505). When determining that the deviation is larger than the allowable deviation (Step S505: NO), the controller 11 updates the accuracy-related property with the optimizer (Step S506). That is, the controller 11 causes the optimizer to vary the parameter value indicated by the accuracy-related property. The controller 11, after completion of Step S506, returns to Step S503.

When determining that the deviation is the allowable deviation or smaller (Step S505: YES), the controller 11 infers the latest accuracy-related property to be the accuracy-related property (Step S507). That is, the controller 11 infers the parameter value providing a deviation of the allowable deviation or smaller to be a parameter value indicated by the accuracy-related property of the working machine 200. The controller 11, after completion of Step S507, terminates the property specifying process.

As described above, this embodiment employs an algorithm for automatically adjusting the accuracy-related property so as to make the processing accuracy to be equal to that of the actual device. The embodiment can thus achieve inference of the accuracy-related property with improved accuracy.

### Embodiment 8

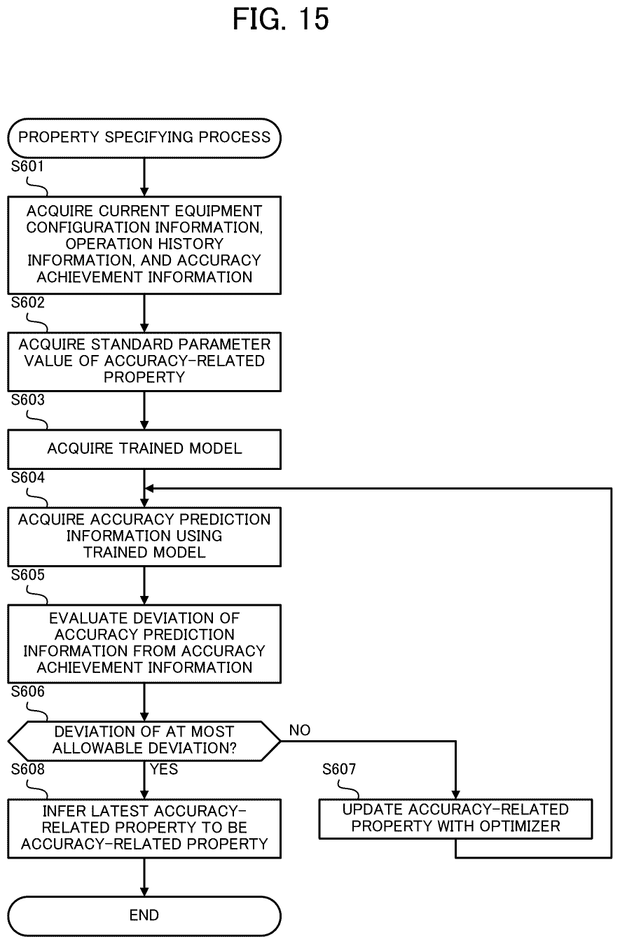

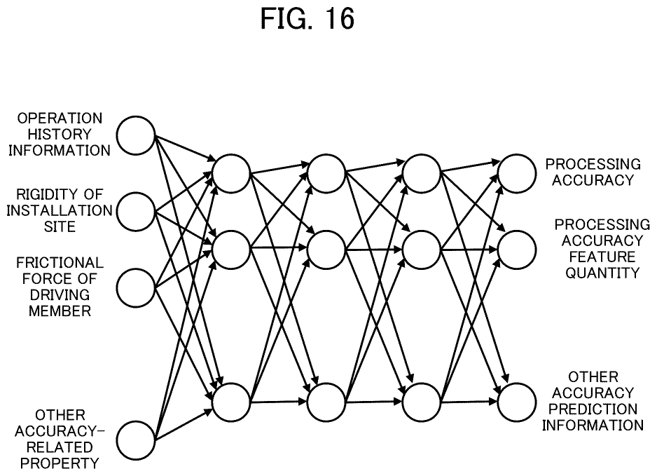

FIG. 15 is a flowchart illustrating a property specifying process executed by a proposal device 100 according to Embodiment 8. In Embodiment 7, every cycle of repeated processes involves coupled analysis, and thus requires a large scale of calculation and suffers from a high processing load. The coupled analysis is replaced with a trained model in this embodiment. As illustrated in FIG. 16, the trained model in this embodiment is established by learning accuracy prediction information to be output in response to input of operation history information and the accuracy-related property, such as a rigidity of the installation site and a frictional force of the driving member. The accuracy prediction information output from the trained model indicates a feature quantity related to processing accuracy. For example, the accuracy prediction information may be a movement trajectory corresponding to the processing accuracy, or a processing accuracy feature quantity of a phenomenon, such as overshoot or quadrant glitch. In this embodiment, the proposal device 100 in the property specifying process evaluates a deviation of the predicated accuracy information acquired from the trained model from the accuracy achievement information, and repeats a series of processes until the deviation reaches the allowable deviation or smaller.

The controller 11 first acquires current equipment configuration information, operation history information, and accuracy achievement information (Step S601). The controller 11, after completion of Step S601, acquires a standard parameter value of the accuracy-related property (Step S602). The controller 11, after completion of Step S602, acquires a trained model (Step S603). The controller 11, after completion of Step S603, acquires accuracy prediction information by means of the trained model (Step S604). Specifically, the controller 11 inputs the operation history information and the standard parameter value of the accuracy-related property into the trained model, and thus acquires the accuracy prediction information.

The controller 11, after completion of Step S604, evaluates a deviation of the accuracy prediction information from the accuracy achievement information (Step S605). That is, the controller 11 calculates a deviation of the feature quantity indicated by the accuracy prediction information from the feature quantity indicated by the accuracy achievement information. The controller 11, after completion of Step S605, determines whether the deviation is at most the allowable deviation (Step S606). When determining that the deviation is larger than the allowable deviation (Step S606: NO), the controller 11 updates the accuracy-related properties with an optimizer (Step S607). That is, the controller 11 causes the optimizer to vary the parameter value indicated by the accuracy-related property. The controller 11, after completion of Step S607, returns to Step S604.

When determining that the deviation is the allowable deviation or smaller (Step S606: YES), the controller 11 infers the latest accuracy-related property to be the accuracy-related property (Step S608). That is, the controller 11 infers the parameter value providing a deviation of the allowable deviation or smaller to be parameter value indicating the accuracy-related property of the working machine 200. The controller 11, after completion of Step S608, terminates the property specifying process.

As described above, the property specifying process involves inferring the accuracy-related property of the working machine 200 on the basis of the accuracy prediction information output from the trained model in this embodiment. The embodiment can thus reduce the processing load for calculation.

In Embodiment 1, the CPU of the controller 11 executes the programs stored in the ROM or the storage 12, and thus performs the functions of the components illustrated in FIG. 4. The controller 11 may also be dedicated hardware in the present disclosure. Examples of the dedicated hardware include single circuits, combined circuits, programmed processors, application specific integrated circuits (ASICs), field-programmable gate arrays (FPGAs), or combinations thereof. In the case where the controller 11 is dedicated hardware, the individual functions of the components may be performed by separate pieces of hardware or may be collectively performed by a single piece of hardware. A part of the functions of the components may be achieved by dedicated hardware, whereas the other part may be achieved by software or firmware. That is, the controller 11 is able to perform the above-described functions by means of hardware, software, firmware, or a combination thereof.

Operational programs that define the operation of the proposal device 100 according to the present disclosure may be applied to an existing computer, such as personal computer or information terminal device, and may cause this computer to serve as the proposal device 100 according to the present disclosure. Such programs may be distributed by any procedure. For example, the programs may be stored in a non-transitory computer-readable recording medium, such as compact disk ROM (CD-ROM), digital versatile disk (DVD), magneto optical (MO) disk, or memory card, and distributed. The programs may also be distributed via a communication network, such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-020618, filed on Feb. 14, 2022, the entire disclosure of which is incorporated by reference herein.

### INDUSTRIAL APPLICABILITY

The present disclosure can be applied to a proposal system that proposes an equipment configuration.

REFERENCE SIGNS LIST
11, 21 Controller
12, 22, 31 Storage
13, 23, 51 Display
14, 24 Manipulation receiver
15, 25 Communicator
26 Drive circuit
27 Motor
28 Encoder
41 Request receiver
81 Control model
82 Mechanism analysis model
100 Proposal device
101 Equipment configuration acquirer
102 Operation history acquirer
103 Accuracy achievement acquirer
104 Property specifier
105 User request acquirer
106 Product information acquirer
107 Equipment configuration determiner
108 Information outputter
200 Working machine
210 Numerical control unit
220 Main unit
221 Tip
222, 222A, 222B, 222C Motor member
223, 223A, 223B, 224 Component
225, 225A, 225C Sliding member
300 First terminal device
400 Second terminal device
500 Display device
600 Server
600A First server
600B Second server
600C Third server
650 Accuracy database
660 Model database
700 Communication network
1000 Proposal system

1. A proposal device comprising:
processing circuitry to
acquire current equipment configuration information indicating a current equipment configuration containing a current component configuration of a working machine and a current control program of the working machine.
acquire operation history information indicating an operation history of the working machine.
acquire accuracy achievement information indicating a processing accuracy achieved by the working machine,
specify an accuracy-related property, based on the current equipment configuration information, the operation history information, and the accuracy achievement information, the accuracy-related property being a property affecting the processing accuracy of the working machine.
acquire a user request for processing accuracy.
acquire product information indicating at least one of a lineup of components applicable to the working machine or a lineup of control programs applicable to the working machine,
determine a proposed equipment configuration, based on the current equipment configuration information, the accuracy-related property, and the product information, the proposed equipment configuration being an equipment configuration that satisfies the user request and that is the current equipment configuration with at least one of the current component configuration or the current control program being changed, and
output proposed equipment related information that is information related to the proposed equipment configuration.

2. The proposal device according to claim 1, wherein the processing circuitry
selects a first trajectory among trajectories drawn by a traveling member while the working machine is processing an object, the traveling member being included in the working machine,
specifies a first component in the current component configuration, the first component being used when the traveling member draws the first trajectory, and
determines, as the proposed equipment configuration, an equipment configuration that is the current equipment configuration with a new component applied in place of the first component, or an equipment configuration that is the current equipment configuration with a new component applied in addition to the first component.

3. The proposal device according to claim 2, wherein the processing circuitry selects, as the first trajectory, based on the current equipment configuration information and the operation history information, a frequently drawn trajectory among the trajectories drawn by the traveling member.

4. The proposal device according to claim 2, wherein the processing circuitry selects, as the first trajectory, based on the current equipment configuration information and the operation history information, a trajectory that readily causes vibration among the trajectories drawn by the traveling member.

5. The proposal device according to claim 2 4, wherein the processing circuitry
specifies one or more candidate components corresponding to the first component from the lineup indicated by the product information, and
determines, as the new component, a candidate component satisfying the user request, among the one or more candidate components.

6. The proposal device according to claim 1, wherein the processing circuitry
specifies a frequency that readily causes vibration among frequencies used while the working machine is processing an object, and
determines, as the proposed equipment configuration, an equipment configuration containing a control program in which the specified frequency is not used.

7. The proposal device according to claim 1, wherein
the processing circuitry, based on accuracy database information containing at least one of (i) simulation information indicating, for each of parameter values each indicating the accuracy-related property, a result of simulation of a feature quantity of a vibration characteristic or processing accuracy or (ii) actual-device experiment information indicating, for each of the parameter values, an experimental result of an experiment for a feature quantity of a vibration characteristic or processing accuracy that is performed using an actual device,
calculates, for each of the parameter values, a deviation of the feature quantity indicated by the accuracy database information from the feature quantity indicated by the accuracy achievement information, and
specifies, as the parameter value indicating the accuracy-related property of the working machine, a parameter value corresponding to a feature quantity that is minimum in the calculated deviation among a plurality of the feature quantities indicated by the accuracy database information.

8. The proposal device according to claim 1, wherein the processing circuitry
calculates, for each of parameter values each indicating the accuracy-related property, using a trained model that is established for the parameter value and that outputs accuracy prediction information in response to input of the operation history information, a deviation of a feature quantity indicated by the accuracy prediction information from a feature quantity indicated by the accuracy achievement information, and
specifies, as the parameter value indicating the accuracy-related property of the working machine, a parameter value that is minimum in the calculated deviation among the parameter values.

9. The proposal device according to claim 1, wherein the processing circuitry
acquires accuracy prediction information, through simulation that outputs the accuracy prediction information in response to input of a parameter value indicating the accuracy-related property and the operation history information,
calculates a deviation of a feature quantity indicated by the accuracy prediction information from a feature quantity indicated by the accuracy achievement information,
sets a standard parameter value as an initial value of the parameter value,
repeats processing of acquiring the accuracy prediction information through the simulation while updating the parameter value with an optimizer until the calculated deviation reaches an allowable deviation or smaller, and
specifies, as the parameter value indicating the accuracy-related property of the working machine, a parameter value provided when the calculated deviation reaches the allowable deviation or smaller.

10. The proposal device according to claim 1, wherein the processing circuitry
acquires accuracy prediction information, using a trained model that outputs the accuracy prediction information in response to input of a parameter value indicating the accuracy-related property and the operation history information,
calculates a deviation of a feature quantity indicated by the accuracy prediction information from a feature quantity indicated by the accuracy achievement information,
sets a standard parameter value as an initial value of the parameter value,
repeats processing of acquiring the accuracy prediction information using the trained model while updating the parameter value with an optimizer until the calculated deviation reaches an allowable deviation or smaller, and
specifies, as the parameter value indicating the accuracy-related property of the working machine, a parameter value provided when the calculated deviation reaches the allowable deviation or smaller.

11. A proposal system comprising:
the proposal device according to claim 1;
a working machine;
and
a display device, wherein
the working machine includes
a storage to store the current equipment configuration information and the operation history information, and
the display device includes
a display to display the proposed equipment related information output from the proposal device.

12. A proposal method comprising:
specifying an accuracy-related property, based on current equipment configuration information, operation history information, and accuracy achievement information, the accuracy-related property being a property affecting a processing accuracy of a working machine, the current equipment configuration information indicating a current equipment configuration containing a current component configuration of the working machine and a current control program of the working machine, the operation history information indicating an operation history of the working machine, the accuracy achievement information indicating a processing accuracy achieved by the working machine;
determining a proposed equipment configuration, based on the current equipment configuration information, the accuracy-related property, and product information, the proposed equipment configuration being an equipment configuration that satisfies the user request and that is the current equipment configuration with at least one of the current component configuration or the current control program being changed, the product information indicating at least one of a lineup of components applicable to the working machine or a lineup of control programs applicable to the working machine; and
presenting proposed equipment related information that is information related to the proposed equipment configuration.

13. A non-transitory computer-readable recording medium storing a program configured to cause a computer to function as:
a property specifier to specify an accuracy-related property, based on current equipment configuration information, operation history information, and accuracy achievement information, the accuracy-related property being a property affecting a processing accuracy of a working machine, the current equipment configuration information indicating a current equipment configuration containing a current component configuration of the working machine and a current control program of the working machine, the operation history information indicating an operation history of the working machine, the accuracy achievement information indicating a processing accuracy achieved by the working machine; and
an equipment configuration determiner to determine a proposed equipment configuration, based on the current equipment configuration information, the accuracy-related property, and product information, the proposed equipment configuration being an equipment configuration that satisfies the user request and that is the current equipment configuration with at least one of the current component configuration or the current control program being changed, the product information indicating at least one of a lineup of components applicable to the working machine or a lineup of control programs applicable to the working machine.
